(19) United States
(12) Patent Application Publication
(10) Pub. No.: US 2016/0090020 A1
(43) Pub. Date: Mar. 31, 2016

(54) APPARATUS AND METHOD FOR SECURING A SCOOTER IN A VEHICLE

(71) Applicant: David Vooght, Newton Abbot (GB)

(72) Inventor: David Vooght, Newton Abbot (GB)

(21) Appl. No.: 14/867,280

(22) Filed: Sep. 28, 2015

(30) Foreign Application Priority Data
Sep. 27, 2014 (GB) 1417305.8

(51) Int. Cl. B60P 3/073; B60R 11/02; B60R 11/00

(52) U.S. Cl. CPC B60P 3/073; B60R 11/00; B60R 11/0264; B60R 2011/0029; B60R 2011/0071

(57) ABSTRACT

An apparatus for securing a scooter with a footplate to a vehicle having a floor includes a main beam having proximal and distal ends and being connectable to the vehicle floor to move between an up, rest position and a down, locking position, the down, locking position including a portion of the main beam extending generally laterally over and across the footplate of a scooter positioned thereunder; actuator means including a follower pin received for limited movement in a slot defined by guide means connected to the main beam, the actuator means being for moving the main beam between the up, rest position and down, locking positions; and latch means for securing the distal end of the main beam to the vehicle floor when in the down, locking position.

### FIELD OF THE INVENTION

This invention relates to devices for securing mobility devices and, more particularly, to an apparatus for securing a mobility device such as a scooter to the inside of a vehicle.

### BACKGROUND OF THE INVENTION

Many people with limited physical capabilities transport themselves around using a mobility scooter or similar mobility device. A typical scooter will have four wheels, an electric motor, bicycle style handlebars, a large padded seat and a footplate. The rear wheels are driven and the front wheels steer. It is commonly driven or moved into a wheelchair access vehicle via a lift or ramp and, the disabled person alights the scooter and moves into the driver seat to drive the vehicle or into a passenger seat. Once inside the vehicle, it is desirable to secure or tie down the scooter, so that it does not move around while the vehicle is moving and, worse, become a massive and dangerous projectile in the event a sudden deceleration or accident.

### SUMMARY OF THE INVENTION

Generally speaking, there is provided an apparatus for securing a mobility device such as a scooter to the inside of a vehicle.

The present invention is directed to an apparatus that is operable to anchor a mobility scooter or similar mobility device into a position from which it cannot move inside of a vehicle. When a mobility scooter is located in the desired position the user will actuate a switch which will lower a powered arm from a vertical parked position into a horizontal position across the middle of a mobility scooter. The powered arm will locate either into the floor or latch to a post secured into the floor (depending on the variant fitted to the vehicle) thereby restricting the movement of the mobility scooter in the event of an accident.

In one embodiment, an apparatus is provided for securing a scooter with a footplate to a vehicle having a floor. The apparatus includes a main beam having proximal and distal ends and being connectable to the vehicle floor to move between an up, rest position and a down, locking position, the down, locking position including a portion of the main beam extending generally laterally over and across the footplate of a scooter positioned thereunder; actuator means including a follower pin received for limited movement in a slot defined by guide means connected to the main beam, the actuator means being for moving the main beam between the up, rest position and down, locking positions; and latch means for securing the distal end of the main beam to the vehicle floor when in the down, locking position.

It is an object of the present invention to provide an improved device for securing mobility devices such as scooters on the inside of a vehicle.

Other objects and advantages will become apparent from the following description of the preferred embodiment.

### BRIEF DESCRIPTION OF THE DRAWINGS

FIG. 1 is a side, elevational view of an apparatus 10 for securing a scooter in a vehicle in accordance with one embodiment of the present invention, with apparatus 10 shown in the generally vertical up and resting position 14 as it would appear when it is not in use.

FIG. 2 is perspective view of the apparatus 10 of FIG. 1

FIG. 3 is a side, elevational view of the apparatus 10 of FIG. 1, with its central beam 18 shown in the generally horizontal position, apparatus 10 being nearly in the fully down, locking position 15, and showing in phantom the scooter footplate 71 that it would be locking down.

FIG. 4 is an enlarged view of a portion of the apparatus 10 of FIG. 3 at detail A and showing the foot beam 19 as its locking knob 52 is nearly fully latched into the keyhole opening 59 of floor socket 3.

FIG. 5 is perspective view of the portion of apparatus 10 of FIG. 3.

FIG. 6 is an enlarged view of a portion of the apparatus 10 of FIG. 5 at detail B and showing the foot beam 19 as its locking knob 52 is nearly fully latched into the keyhole opening 59 of floor socket 3.

FIG. 7 is a perspective view of the floor socket 3 of the apparatus 10 of FIG. 6 showing the underside of the floor socket.

FIG. 8 is a side, elevational view of the apparatus 10 of FIG. 1 shown in the fully down, locking position 15.

FIG. 9 is a perspective view of the apparatus 10 of FIG. 8.

### DESCRIPTION OF THE PREFERRED EMBODIMENT

For the purpose of promoting an understanding of the principles of the invention, reference will now be made to the embodiments illustrated in the drawings and specific language will be used to describe the same. It will nevertheless be understood that no limitation of the scope of the invention is thereby intended, and any alterations and further modifications in the illustrated device and further applications of the principles of the invention as illustrated are being contemplated as would normally occur to one skilled in the art to which the invention relates.

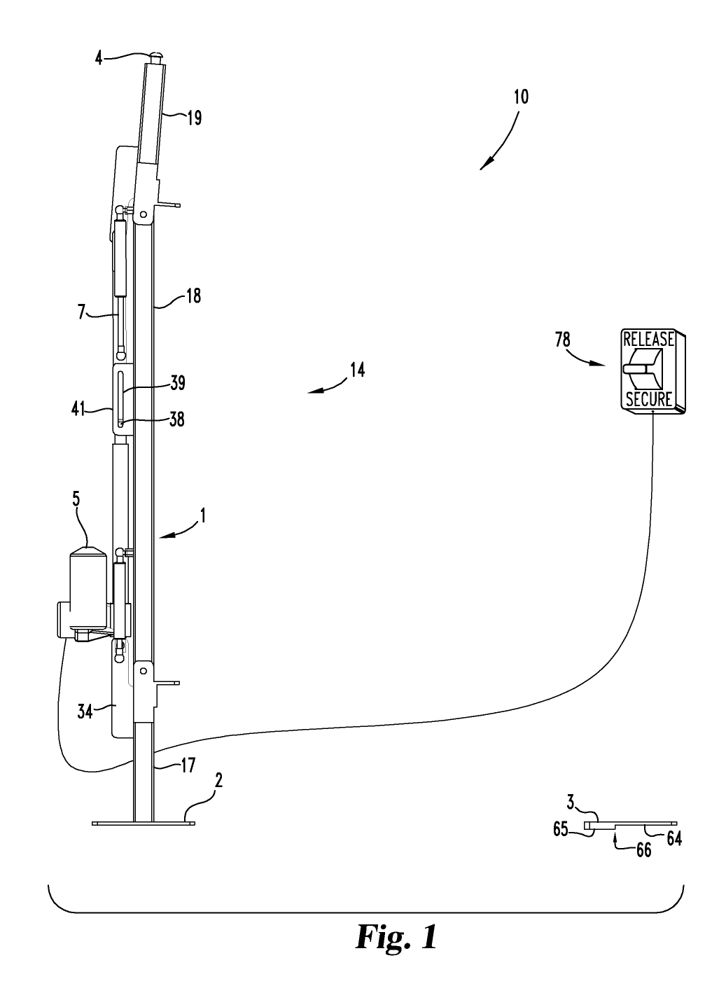

Referring to the FIGS. 1, 2, 8 and 9, there is shown an apparatus 10 for securing a mobility device such as a scooter to the inside of a vehicle. A typical scooter (not shown) has four wheels, an electric motor, bicycle style handlebars, a large padded seat and a footplate. The rear wheels are driven by the electric motor, and the front wheels are steered by the user via the handlebars. Other configurations of scooters are known and/or contemplated (having only three wheels, for example), but the present invention is directed to all such mobility devices that have a footplate connecting the front and rear portions of the mobility device and being located near to the ground.

Briefly, FIG. 1 illustrates the device in the vertical position as it would be when not in use. It is bolted to the floor of an adapted vehicle through a plate 2. A main beam 1 is raised and lowered via a toggle switch 78 and powered by a motor 5 with joint at the end of the beam so it pivots using a gas strut 7. The device locks into floor socket 3 by the locating pin 4 latching into it.

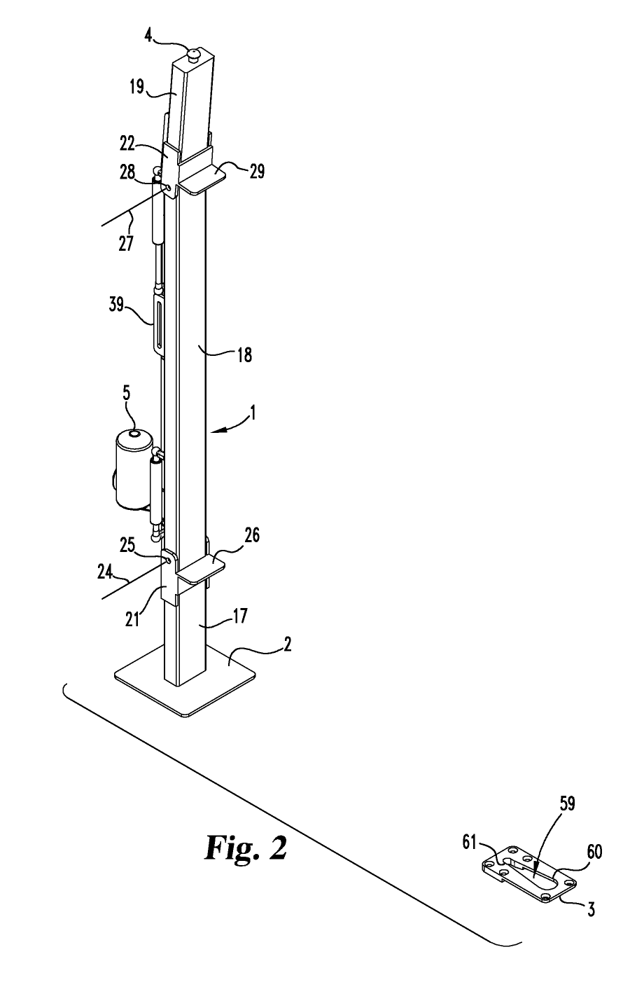

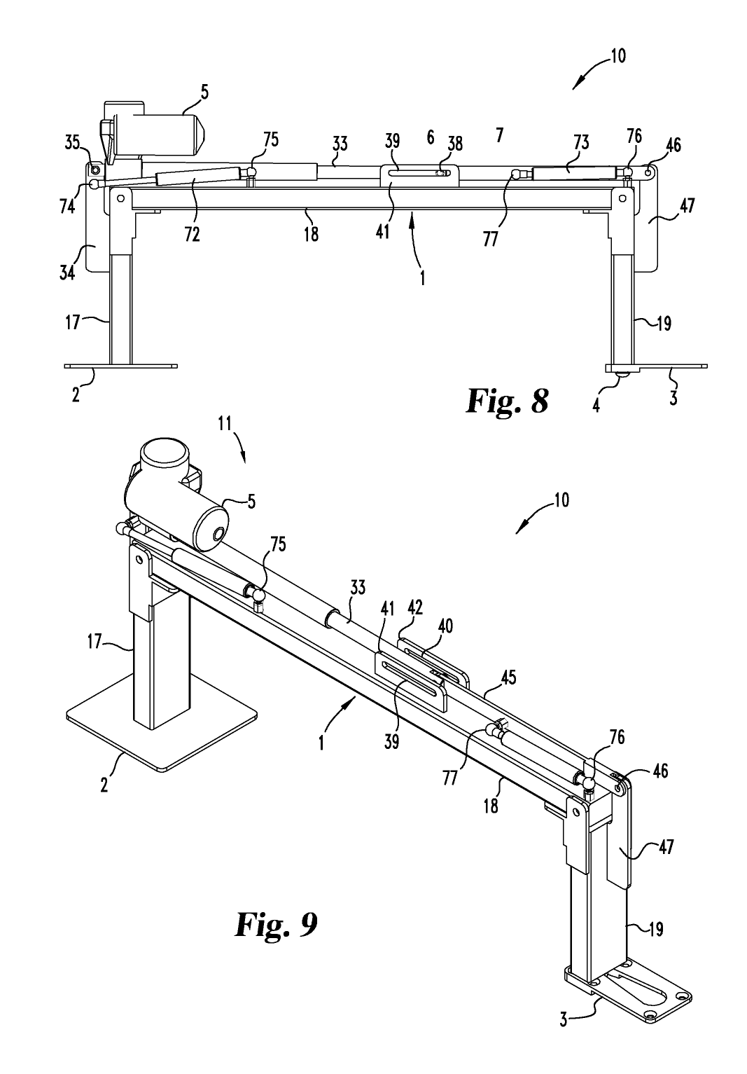

Apparatus 10 generally includes a main beam 1, plate 2, a floor socket (or latch) 3 and an actuator assembly 11 that articulates (that is, one or more of components are moved via hinged interconnections) apparatus 10 between an up, resting position 14 (FIGS. 1 and 2) and a down, locking position 15 (FIGS. 8 and 9). Main beam 1 (or arm) includes a base beam 17, a central beam 18, a foot beam 19 (or arm) and proximal and distal hinge members 21 and 22. Base beam 17 is connected to plate 2, which is mounted to the floor of the vehicle in any appropriate manner

Central beam 18 is hingedly connected to base beam 17 by hinge member 21 to pivot about a pin 25. Hinge member 21 is fixedly connected to base beam 17 and includes a stop plate 26 that extends about 90 degrees (that is, generally horizontally) from the generally vertically extending base beam 17.

Foot beam 19 is hingedly connected to central beam 18 by hinge member 22 to pivot about an axis 27 via a pin 28. Hinge member 22 is fixedly connected to foot beam 19 and includes a stop plate 29 that extends about 90 degrees from the length (that is, the long axis) of foot beam 19.

Actuator assembly 11 includes a motor 5 with linearly extending/retracting output rod 33 (i.e. a linear actuator), the motor 5 being pivotally mounted to the base beam 17 via a bracket member 34, which is fixed to base beam 17, and whereby motor 5 is pivotally mounted to bracket member 34 by a pin 35. At the distal end of the motor's output rod 33 is a follower in the form of a pin 38 that rides within slots 39 and 40 defined by guide plates 41 and 42, respectively, that are fixed to extend upwardly (as shown in FIG. 9) from central beam 18. A connector rod 45 is connected to and extends from the distal end of output rod 33, the two here being connected together by the pin 38, and toward the distal end of central beam 38 where it is pivotally connected via a pin 46 to a bracket 47 that is fixedly connected to foot beam 19, as shown.

Referring to FIG. 4, at the distal end 50 of foot beam 19 is the locating pin 4 (a first member) that is sized and configured to engage and releasably lock with the floor socket 3 (a second member). Locating pin 4 has a main shank 51 connected to and extending from distal end 50, and then at the distal end of shank 51 is a larger sized locking knob 52. Knob 52 has a generally flat surface (or ledge) 55 extending radially outwardly from its junction to shank 51 and has a rounded outer surface 56 at its outermost side.

Referring to FIGS. 4, 6, 7, 10 and 11, floor socket 3 is a plate defining a keyhole shaped opening 59 that is sized, at its outer end 60 (that is, the end to be the farthest away from the mounting of base beam 17 (here, via plate 2) to the vehicle floor), large enough for locking knob 52 to pass therethrough, and that is sized, at its inner end 61 (the end closest to the mounting of base beam 17 to the vehicle floor), only wide enough for the narrower diameter shank 51 to be received therein. Floor socket 3 also is thinner at its outer end 64 than at its inner end 65, and at a portion near the junction 66 of the thinner/thicker portions 64/65. And, on opposite sides of the opening 59 and at its underside, floor socket 3 is ramped (at 68/69) to facilitate a smooth entry of the shank 51 from the larger outer end 60 into the smaller inner end 61 of opening 59 as the flat surface ledge 55 engages ramps 68/69 on the underside of floor socket 3 and slides to a snug locking position at the inner opening end 61.

Referring to FIGS. 8 and 9, apparatus 10 further includes two gas struts (or gas shocks) 72 and 73 to dampen the articulating movement of the base, central and foot beams 17-19. Inner gas strut 72 is connected at one end 74 to bracket 34 and at its opposite end 75 to central beam 18, and outer gas strut 73 is connected at one end 76 to the outer end of central beam 18 and at its opposite end 77 to rod 45.

In assembly, apparatus 10 is installed by mounting the base beam 17 via its plate 2 to the vehicle floor and by mounting floor socket 3 also to or in the vehicle floor (preferably flush with the floor) at such distance from the mounting of plate 2 so as to leave the desired gap between beams 17 and 19 to accommodate the intended scooter and as defined by the length of central beam 18. Where the lengths of central beam 18 and the actuator assembly 11 are adjustable, the positionment of floor socket 3 is selected within the range of such adjustability and the width of the scooter.

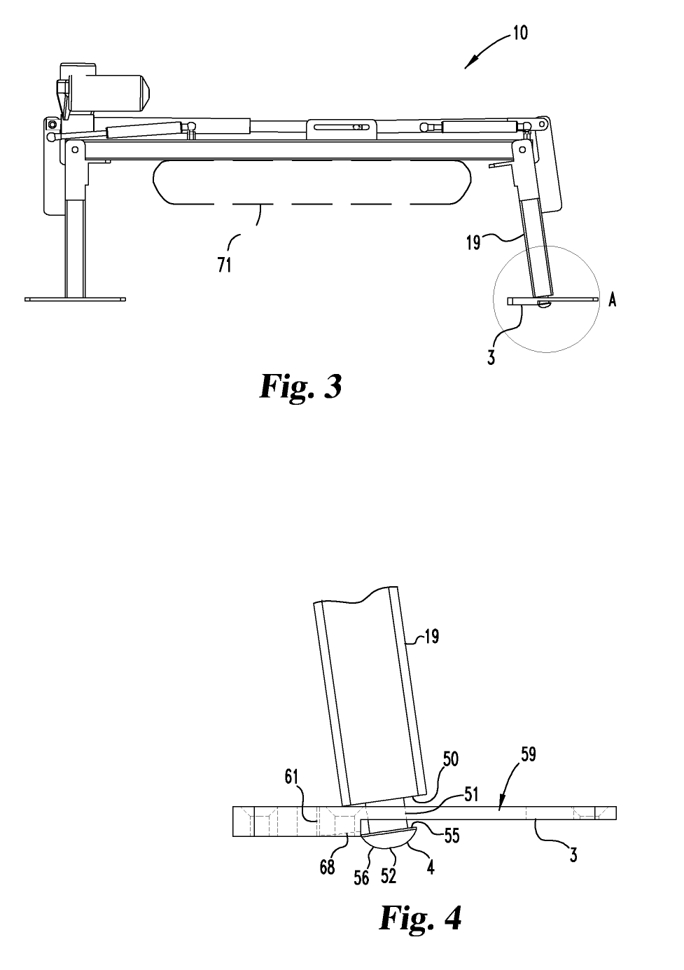

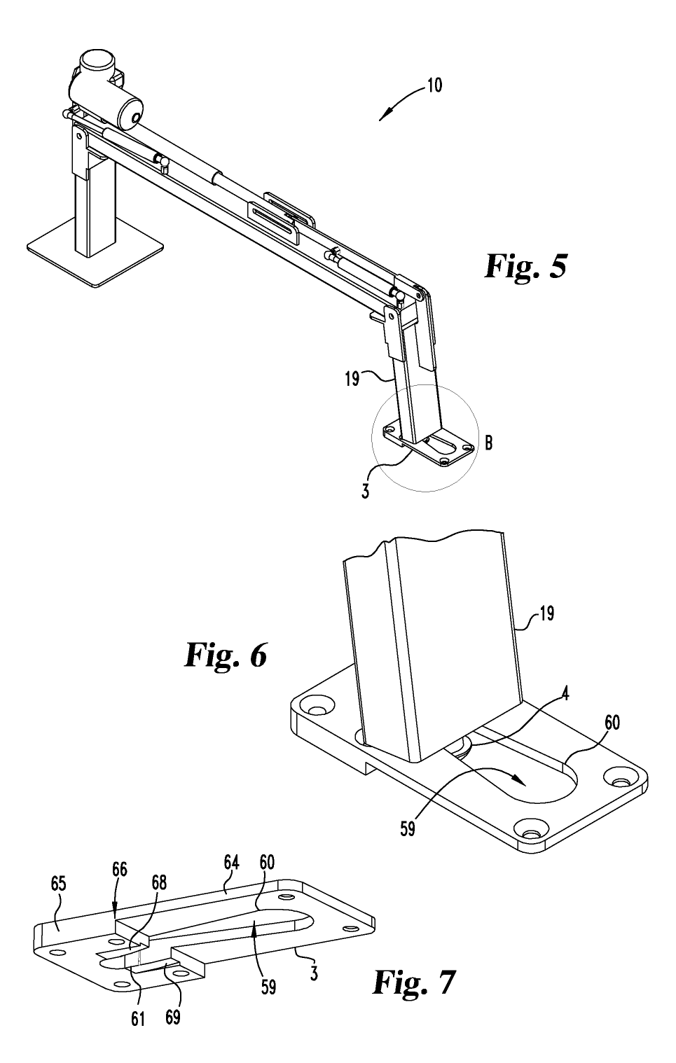

In use, once the scooter is maneuvered into position, as shown at 71 in FIG. 3, the user activates motor 5 (via an appropriate switch, such as toggle switch 78 or a remote or other device), which causes output rod 33 to extend, its outer end being guided by the pin 38 riding within slots 39 and 40, and central beam 18 is forced to pivot down about its hinged connection at pin 35. Likewise, as pin 38 moves within slots 39 and 40, connector rod 45 moves outwardly, and foot beam 19 is forced to bend at its hinge axis at pin 28. As beams 18 and 19 bend, central beam 18 swings down over the scooter 71, and locating pin 4 approaches floor socket 3 until: central beam 18 has reached it pivot limit (via hitting stop plate 26); foot beam 19 has reached its pivot limit (via stop plate 29 hitting central beam 18; and locating pin 4 has entered all the way into a snug locking engagement within the small, inner end 61 of keyhole opening 59, as shown in FIGS. 8 and 9, which constitutes the down, locking position 15. To unlock the scooter, the toggle switch 78 or similar switch is activated to reverse the motor 5, which retracts output rod 33, and central and foot beams 18 and 19 are pivoted in the opposite directions until apparatus 10 is in its up, resting position (FIGS. 1 and 2) and now stowed out of the way.

While electric motor 5 minimizes the effort required by the operator to use apparatus 10, alternative embodiments are contemplated wherein apparatus 10 lacks a motor, and the beams 17-19 are manually moved between the up, resting and down, locking positions 14 and 15. In this configuration, the gas struts 72 and 73 are particularly helpful to avoid damage to the scooter or user from inadvertently dropping the assembly 10 before it has reached a position resting on and locking with the vehicle floor. Likewise, the gas struts can be omitted from the assembly 10 or such dampening action can be achieved in other means, such as friction bushings or similar elements at the hinged connections between the beams.

Alternative embodiments are contemplated wherein central beam 18 and some portion of the actuator assembly 11 (that is, one or more of motor 5, output rod 33, connector rod 45 and other components connected thereto) are made for their length to be adjustable. That is, apparatus 10 is intended for use with scooters and/or similar mobility devices which might be of varying widths. The gap between base beam 17 and foot beam 19 in the down, locking position 15 is therefore contemplated to be made to readily accommodate such mobility device therebetween, but to not be too wide where apparatus 10 takes up more space than is necessary. Alternative embodiments are also contemplated wherein the base and foot beams 17 and 19 are made to be vertically adjustable to likewise readily accommodate the scooter or other mobility device contemplated for use therewith.

Alternative embodiments are contemplated wherein the main beam 1 is mounted, not to the vehicle floor, but to any other part of the vehicle, so long as it moves between an up, rest position out of the way and a down, locking position securing the scooter. For example, main beam 1 could lack a base beam 17, and the central beam 18 would be movably (e.g. pivotally) connected to some structure of or connected directly to the vehicle's side wall.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed is:

1. A disabled person's scooter locking device, comprising:
a remotely operated and powered arm with first and second ends, the first end of said arm being hingedly mounted to the vehicle, and
a floor mounted latch into which the second end of said arm locks upon pivoting said arm relative the vehicle, thereby securing a scooter positioned between the vehicle floor and said arm.

2. The disabled persons scooter locking device according to claim 1 further including an actuator assembly with an electrical motor for moving said arm between an up, resting position and a down, locking position, the down, locking position being characterized by said arm being across and over the scooter and the second end of said arm being engaged with the floor mounted latch.

3. The disabled persons scooter locking device according to claim 1 wherein, in the down, locking position, said arm is held in a locking condition to the vehicle floor by said floor mounted latch, which is sized and configured to lockingly receive a portion of said arm when in the down, securing position.

4. A disabled persons scooter locking device according to claim 2 further including a toggle switch electrically connected with the electric motor, the toggle switch being operable to control the actuator assembly.

5. An apparatus for securing a scooter with a footplate to a vehicle having a floor, comprising:
a main beam having proximal and distal ends and being connectable to the vehicle floor to move between an up, rest position and a down, locking position, the down, locking position including a portion of said main beam extending generally laterally over and across the footplate of a scooter positioned thereunder;
actuator means including a follower pin received for limited movement in a slot defined by guide means connected to said main beam, said actuator means being for moving said main beam between the up, rest position and down, locking positions; and
latch means for securing the distal end of said main beam to the vehicle floor when in the down, locking position.

6. The apparatus for securing a scooter of claim 5 wherein said main beam is connected to the vehicle floor.

7. The apparatus for securing a scooter of claim 6 wherein said main beam includes a central beam having first and second ends and a foot beam with first and second ends, the foot beam being hingedly connected at its first end to the second end of the central beam.

8. The apparatus for securing a scooter of claim 7 further including limit means connected to at least one of the central beam and the foot beam for limiting hinged movement in at least one direction of the foot beam's movement relative to the central beam.

9. The apparatus for securing a scooter of claim 8 wherein said limit means includes a stop plate extending generally orthogonally from one of the central beam and the foot beam and proximal to the hinged connection between the central beam and the foot beam.

10. The apparatus for securing a scooter of claim 7 wherein said main beam includes a base beam having first and second ends and being hingedly connected at its second end to the first end of the central beam and being fixedly connectable at its first end to the vehicle floor.

11. The apparatus for securing a scooter of claim 10 further including limit means connected to at least one of the central beam and the base beam for limiting hinged movement in at least one direction of the central beam's movement relative to the base beam.

12. The apparatus for securing a scooter of claim 11 wherein said limit means includes a stop plate extending generally orthogonally from one of the central beam and the base beam and proximal to the hinged connection between the central beam and the base beam.

13. The apparatus for securing a scooter of claim 1 wherein said actuator means includes a linear actuator mounted at its first end to pivot relative to the vehicle and being mounted at its second end to and for limited sliding movement relative said main beam.

14. The apparatus for securing a scooter of claim 7 wherein said actuator means includes a linear actuator mounted at its first end to pivot relative to the vehicle and being mounted at its second end to and for limited sliding movement relative said main beam, and wherein said actuator means further includes a connector rod having first and second ends and being connected at its first end to the second end of the linear actuator and at its second end to the foot beam.

15. The apparatus for securing a scooter of claim 14 wherein the actuator means includes a follower pin connected to the second end of the linear actuator and to the first end of the connector rod and includes guide plate means connected to the central beam and defining slot means for receipt of and permitting limited movement of the follower pin.

16. The apparatus for securing a scooter of claim 5 wherein said main beam includes a central beam having first and second ends and a foot beam with first and second ends, the foot beam being hingedly connected at its first end to the second end of the central beam, and wherein in moving to the down, locking position said actuator means and said latch means operate to automatically secure the second end of said foot beam to the vehicle floor.

17. The apparatus for securing a scooter of claim 5 wherein said main beam includes a central beam having first and second ends and a foot beam with first and second ends, the foot beam being hingedly connected at its first end to the second end of the central beam, and wherein said latch means includes a locating pin extending from the foot beam and a floor socket mountable to the vehicle floor, the floor socket defining an opening for locking receipt of the locating pin.

18. A method for securing a scooter with a footplate to a vehicle having a floor, comprising:
providing an apparatus including a main beam having proximal and distal ends and being connectable to the vehicle floor to move between an up, rest position and a down, locking position, the down, locking position including a portion of said main beam extending generally laterally over and across the footplate of the scooter positioned thereunder; actuator means for moving said main beam between the up, rest position and down, locking positions;
and latch means including a first member at the distal end of the main beam and a second member for connecting with the vehicle floor and for lockingly engaging with the first member when in the down, locking position;
connecting the proximal end of said main beam to the vehicle floor;
connecting the second member to the vehicle floor a spaced distance from the mounting of the proximal end to the vehicle floor;
positioning the scooter with its footplate being between the proximal end of said main beam and the second member;
moving the main beam from the up, rest position to the down, securing position so that the first member lockingly engages with second member.
